(19) United States
(12) Patent Application Publication
(10) Pub. No.: US 2024/0426475 A1
(43) Pub. Date: Dec. 26, 2024

(54) DEVICE FOR CHEMICAL LOOPING COMBUSTION IN LIQUID MEDIUM

(71) Applicants: UNIVERSITÉ DE LORRAINE, NANCY (FR); CENTRE NATIONAL DE LA RECHERCHE SCIENTIFIQUE, PARIS (FR)

(72) Inventors: Michel MOLIERE, BELFORT (FR); Jean-Noël JAUBERT, NANCY (FR); Romain PRIVAT, NANCY (FR)

(73) Assignees: UNIVERSITÉ DE LORRAINE, NANCY (FR); CENTRE NATIONAL DE LA RECHERCHE SCIENTIFIQUE, PARIS (FR)

(21) Appl. No.: 18/698,592

(22) PCT Filed: Oct. 2, 2022
(86) PCT No.: PCT/FR2022/051856

§ 371 Date: Apr. 4, 2024

(30) Foreign Application Priority Data
Oct. 4, 2021 (FR) FR2110447

(51) Int. Cl. F23C 10/08; F23C 10/00

(52) U.S. Cl. CPC F23C 10/08; F23C 10/005

(57) ABSTRACT

A device for chemical looping combustion of a fuel, operating in the liquid phase and including: a tank receiving a liquid including an oxidizing agent and a reducing agent, an oxidation loop including: a first conduit, a first device for injecting a first motor fluid including dioxygen, configured for introducing the first motor fluid into the first conduit, and a first separating device for separating the first motor fluid from the liquid and for sending the liquid to the tank, a reduction loop including: a second conduit, a second device for injecting a second motor fluid including a fuel that includes carbon, configured for introducing the second motor fluid into the second conduit, and a second separating device, configured for separating the second motor fluid from the liquid.

### FIELD

The invention relates to a chemical looping combustion (CLC) device. The invention also relates to a combustion method using such a device.

### BACKGROUND

A chemical looping combustion method is an indirect combustion method which involves a fuel and a comburent, is broken down into two redox reactions and uses for this purpose a redox couple denoted R/O, where R designates the reducing agent and O the oxidizing agent. The terms reducing agent and oxidizing agent are used in this document to designate respectively the “carrier of oxygen in the reduced state” (i.e. R) and the “carrier of oxygen in the oxidized state” (i.e. O), alternative terminology often used in chemical looping combustion methods.

The reducing agent may be a metal, denoted M, and the oxidizing agent may be an oxide of said metal, denoted MO. The designation MO does not necessarily mean that the metal M is divalent, the atomic ratio M/O being variable.

The fuel comprises carbon and the comburent comprises dioxygen (also called “oxygen” in this document). The comburent and the fuel may be in solid, liquid or preferably gaseous form, independently of one another.

The fuel may be a hydrocarbon, for example methane, and the comburent may be air, for example. By way of illustration, the chemical looping combustion of methane (CH₄) in air (O₂+k N₂, with k=3.76) is written as:

4M+2(O₂+kN₂)→4MO+2kN₂+Q₁ (1)

CH₄+4MO→CO₂+2H₂O+4M+Q₂ (2)

Q1 and Q2 are the heats of the reactions (1) and (2).

The overall chemical result, the sum of reactions (1) and (2), is equivalent to that of a direct combustion reaction:

CH₄+2(O₂+kN₂)→CO₂+2H₂O+2kN₂+(Q₁+Q₂) (3)

The separation of the overall combustion reaction (3) into two independent reactions (1) and (2) makes it possible to avoid mixing the carbon dioxide (CO₂) produced by reaction (2) with the gaseous effluent from reaction (1), which includes dinitrogen (N₂) accompanying the comburent dioxygen (O₂), as well as a part of any unreacted oxygen. Thus, it is possible to easily capture and store CO₂ and to discharge the gaseous effluent into the air, and the CO₂ may be isolated simply by condensation of the accompanying water.

In conventional chemical looping combustion methods, the oxidizing agent and reducing agent are in solid form, for example Ni/NiO; Fe/Fe₂O₃; Cu/CuO, etc. This requires periodic regeneration of the oxidizing agent and reducing agent; this involves manual or automatic mechanical intervention, which disrupts the method.

The use of oxidizing and reducing agents included in a liquid phase makes it possible to greatly improve this aspect of chemical looping combustion methods by facilitating, through hydraulic transport, the exchanges of reducing agent and oxidizing agent between the different parts of the combustion device.

Documents U.S. Pat. Nos. 3,945,804 and 5,478,380 describe methods involving redox reactions between a redox couple in liquid phase and liquid or gaseous reagents. However, these two methods are not strictly speaking combustion methods and therefore do not share the same objectives of energy efficiency and capture of the gases produced. In addition, these methods have limitations from the point of view of both safety and reliability.

Document US 2011/0117004 A1 describes a chemical looping combustion method in liquid phase implemented in two reactors in which the oxidation reaction and the reduction reaction respectively take place. The roles of the reactors are periodically reversed to ensure their regeneration, by swapping round the reactive fluid supplies.

This method also presents shortcomings in terms of safety and efficiency.

To be specific, reversing the role of the reactors requires that they first be purged using an inert gas, which slows down the method or forces the use of additional reactors to continue combustion while the initial reactors are purged. In addition, these purges make the capture of gaseous effluents difficult because these gases must be separated from the purge gas which are contaminated by gaseous combustion byproducts.

Furthermore, the speed of the reaction decreases as the oxidizing or reducing agent is consumed in a reactor before the roles are reversed, due to the progressive depletion of said reactor in oxidizing (respectively reducing) species, which reduces the efficiency of the method.

### SUMMARY

The invention aims to overcome these drawbacks, and to propose a device allowing the implementation of a method for chemical looping combustion in liquid phase that is both continuous, efficient and safe and allows simple capture of gaseous effluents.

To this end, the invention relates to a device for chemical looping combustion of a fuel, comprising:
at least one tank arranged to receive a liquid comprising at least one oxidizing agent and at least one reducing agent together forming at least one redox couple,
an oxidation loop comprising:
   a first conduit comprising a first inlet opening into the tank, arranged to take in a first part of the liquid comprising at least reducing agent, and a first outlet,
   a first injection device, connected to a first inlet for a first driving fluid comprising dioxygen and preferably devoid of carbonaceous molecules, and arranged to introduce the first driving fluid into the first conduit, where said first driving fluid is in contact with the reducing agent, at least a fraction of which is then oxidized to an oxidizing agent, and
   a first separation device connected to the first outlet and arranged to separate the first driving fluid, depleted in dioxygen, from the liquid and to return the separated liquid to the tank,
a reduction loop comprising:
   a second conduit comprising a second inlet opening into the tank, arranged to take in a second part of the liquid comprising at least oxidizing agent, and a second outlet, and
   a second injection device connected to an inlet for a second driving fluid comprising a fuel comprising carbon and preferably devoid of inert molecules, and arranged to introduce the second driving fluid into the second conduit, where said second driving fluid is in contact with the oxidizing agent, at least a fraction of which is then reduced to a reducing agent, and
   a second separation device connected to the second outlet and arranged to separate the second driving fluid, enriched with carbon dioxide, from the liquid and to return the separated liquid to the tank.

Such a device makes it possible to operate continuously and dispenses with any intervention consisting in exchanging the oxidizing and reducing agents.

To be specific, the oxidizing agent from the first part of the liquid and the reducing agent from the second part of the liquid are returned to the tank where they are thus available to be taken into the reduction loop and the oxidation loop, as just described.

In addition, safety of the device is ensured by the separation, within distinct loops, of the fluids comprising the fuel and the comburent. Lastly, it allows efficient capture of the gaseous effluents as it includes outlets from the two loops which are separated from one another and separated from the tank atmosphere.

In this document, for the sake of simplicity, the term “liquid” is used to designate both a single liquid phase and several liquid phases in contact with one another. This liquid may potentially contain solid particles dispersed in the liquid phase or in at least one of the liquid phases.

The tank may be a single tank, or the device may comprise several tanks in hydraulic communication with one another.

The oxidation loop and the reduction loop may be rapid circulation loops.

The liquid may comprise one or more redox couples, as well as auxiliary agents, for example fluxing agents, a meltable mixture which may contain solid particles, and/or oxidation catalysts.

The liquid may be single-phase or two-phase.

When the liquid is two-phase, one of the phases, from which the first part of the liquid is taken, comprises at least the reducing agent and the other phase, from which the second part of the liquid is taken, comprises at least the oxidizing agent.

The oxidizing and reducing agents may be in liquid form or in the form of solid particles dispersed in the liquid.

If the oxidizing and reducing agents are in liquid form, they may be miscible with one another or immiscible.

The device may also include at least one system for recovering heat from the liquid.

The first separation device and the second separation device may each comprise:
a tapping connection via which the first or second separation device is connected to the first or second conduit, respectively,
a vent opening out of the tank, and
a liquid discharge conduit comprising a lower end opening into the tank.

Each of the vents may comprise a gas analyzer, in particular an O₂ analyzer, preferably in the oxidation loop, or a CO₂ analyzer, preferably in the reduction loop.

The lower end of the discharge conduit may be arranged to open into the liquid contained in the tank.

The device may also comprise a pressurized inert gas circuit, the inert gas comprising water vapor or nitrogen, said inert gas circuit comprising:
an inert gas supply conduit opening into a top part of the tank via a first valve, and
an outlet vent opening into the top part of the tank via a second valve.

The top part is an upper part of the tank relative to the direction of gravity, which is not intended to receive the liquid.

The inert gas circuit may preferably comprise a CO₂, CO or unburned hydrocarbon detector, and/or an O₂ detector.

The invention also relates to a method for chemical looping combustion using the preceding device, the method comprising steps of:
placing in the tank a liquid containing at least one oxidizing agent and reducing agent,
introducing the first driving fluid into the first conduit by means of the first injection device, and taking in, by the driving effect, the first part of the liquid through the first inlet,
circulating the liquid in the first conduit, bringing the liquid and the first driving fluid into contact and reaction between the reducing agent and the dioxygen,
separating, in the first separation device, the liquid and a first gaseous effluent resulting from the reaction between the first driving fluid and the liquid, returning the separated liquid to the tank and discharging the first gaseous effluent,
introducing the second driving fluid into the second conduit by means of the second injection device and taking in, by the driving effect, the second part of the liquid through the second inlet,
circulating the liquid in the second conduit, bringing the liquid and the second driving fluid into contact and reaction between the oxidizing agent and the fuel, and
separating, in the second separation device, the liquid and a second gaseous effluent resulting from the reaction between the second driving fluid and the liquid, returning the separated liquid to the tank and discharging the second gaseous effluent.

The gaseous effluents are transferred “outside the device”, that is to say beyond the vents.

Where the effluent consists essentially of nitrogen, outside the device could simply be the ambient air or a heat exchange unit in which heat will be recovered from this gaseous effluent.

Where the effluent consists essentially of CO₂ and H₂O vapor, outside the device could be a post-treatment unit comprising for example recovery of heat from this gaseous effluent, condensation of H₂O and sequestration of the CO₂.

A ratio of the flow rates of injection of the first and second driving fluids into the first and second conduits, respectively, may be kept constant and be chosen in such a way as to react the fuel and the dioxygen in generally stoichiometric proportions in the device.

This feature allows continuous operation of the combustion device by maintaining substantially constant quantities of oxidizing agent and reducing agent in the tank, because the quantities of oxidizing agent and reducing agent then remain unchanged over time within the tank.

The method may also include a step of:
flushing an atmosphere of the tank with an inert gas.

This step makes it possible to maintain an inert atmosphere in the tank.

The method may also include a step of measuring a level of CO2 and/or a level of O2 in the atmosphere of the tank.

This step makes it possible to check the sealing of the oxidation and reduction loops.

A pressure of the atmosphere of the tank may be kept higher than both a pressure in the first separation device and a pressure in the second separation device, by at least partially closing a vent valve of the tank.

Thus, it is possible to create in the atmosphere of the tank, a pressure which is higher—by a few tens of kilopascals, for example—than the pressures prevailing in the two separation devices, by at least partially closing a vent valve of the tank.

The entire device may be maintained at a pressure which is higher than a pressure outside the device and which is greater than or equal to 100 kilopascals.

Thus, it is possible to maintain the entire device, in other words the atmosphere of the tank, the liquid it contains and consequently the fluids supplied to it, at a pressure higher than the pressure prevailing “outside the device” that is, beyond the vents.

This overpressure may be of the order of several bar or even several tens of bar. This feature makes it possible to improve the compactness of the device by reducing the volume of the gases used therein.

The reducing agent may comprise copper in metallic form Cu(0) and/or in the form of cuprous oxide (Cu₂O), the oxidizing agent then comprising copper in the form of cupric oxide (CuO), the reducing agent and oxidizing agent being contained in the liquid in the form of dispersed solid particles.

The liquid may comprise a fluxing oxide such as for example V₂O₅, MoO₃ or M(I)₂O, M(1) designating an alkali metal.

The reducing agent may comprise at least one metal or oxide of a metal chosen from copper, iron, nickel, chromium, molybdenum, tungsten, vanadium and cerium, the oxidizing agent then comprising at least one other oxide of the same metal having a higher degree of oxidation.

The liquid then comprises a single liquid phase.

The oxidizing agent and the reducing agent may be in liquid form and/or in the form of solid particles dispersed in the liquid.

The liquid may contain at least one auxiliary agent in liquid form, chosen for example from a carbonate, sulfate, borate, vanadate, chromate, molybdate, or tungstate of an alkaline cation.

The liquid may also contain at least one flux chosen from oxides of alkali metals, vanadium, molybdenum, chromium and tungsten.

The liquid may also contain an oxidation catalyst comprising, for example, gold, silver or platinum.

The reducing agent may comprise at least one metal chosen from tin, bismuth and lead, the oxidizing agent then comprising at least one oxide of the same metal.

The liquid then comprises two liquid phases, comprising respectively the reducing agent and the oxidizing agent.

The liquid may contain bismuth, lead and/or antimony as fluxing agent for tin in metallic form.

The liquid may contain an oxide of silicon, vanadium, boron, molybdenum and/or an alkali metal as fluxing agent for tin oxide.

The liquid may contain an oxide of zinc, boron and/or lead as fluxing agent for bismuth oxide.

The liquid may contain bismuth as fluxing agent for metallic lead.

The liquid may contain an oxide of silicon, vanadium, boron, molybdenum and/or an alkali metal as fluxing agent for lead oxide.

The oxidizing agent may be in liquid form forming one of the liquid phases and/or in the form of solid particles dispersed in the liquid phase, which then comprises at least one auxiliary agent in liquid form, chosen for example from a carbonate, sulfate, borate, vanadate, chromate, molybdate, or tungstate of an alkaline cation.

The liquid may also contain an oxidation catalyst comprising, for example, gold, silver or platinum.

### BRIEF DESCRPTION OF THE FIGURES

FIG. 1 schematically depicts a combustion device according to a first embodiment of the invention,

FIG. 2 is a diagram showing the principle of operation of the taking-in and separation devices of the oxidation and reduction loops of FIG. 1,

FIG. 3 is a schematic view showing a tank and a heat recovery device of the combustion device of FIG. 1, the tank having a single compartment,

FIG. 4 is a schematic view of a tank according to a second embodiment of the invention, the tank in this case being made up of three separate compartments hydraulically bridged to one another,

FIG. 5 is a schematic view of a tank according to a third embodiment of the invention: the tank, which in this case consists of a capacity split into two compartments separated by walls and hydraulically bridged to one another, comprises a heat recovery device, and

FIG. 6 is a schematic view of a device according to a fourth embodiment of the invention, comprising an inert gas circuit.

### DETAILED DESCRIPTION

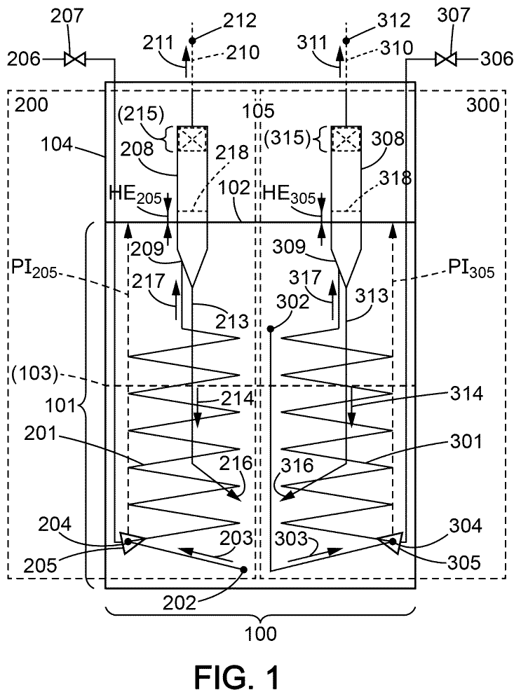

A chemical looping combustion device according to a first embodiment of the invention is shown in detail in FIG. 1 and more schematically in FIG. 3.

The device 1 comprises a tank 100 which contains a certain volume of liquid 101 comprising at least one reducing agent and at least one oxidizing agent. The device 1 comprises an oxidation loop 200 and a reduction loop 300.

The tank 100 is preferably closed, that is to say limited by sealed walls 104 which prevent heat loss, in particular by radiation, and contamination of the liquid 101 by external pollutants. It is preferably also thermally insulated. The tank is made up of a single compartment, as shown in FIG. 3.

In the tank 100, the liquid 101 defines a free surface 102, which is substantially flat when the device is stopped. In the first embodiment, shown in FIG. 1, the liquid 101 is two-phase and therefore comprises an interface 103 between a phase mainly comprising the reducing agent and a phase mainly comprising the oxidizing agent.

The oxidation loop 200 comprises at least a first conduit 201 which has for example a serpentine shape.

This first conduit 201 has a first inlet 202 opening into the tank 100 and intended to take in the liquid 101. In the case of a two-phase liquid 101, the first inlet 202 opens into the phase comprising reducing agent.

Thus, the part of the liquid taken in through the first inlet 202 contains reducing agent, whether the liquid 101 is single-phase or two-phase.

The first conduit 201 comprises, at an injection point 204, a first injection device 205 which comprises an intake 206 for a first driving fluid comprising for example air, which is delivered through a first valve 207.

The first injection device 205 is a device for driving liquid by means of a gas, or “DELG”, which may be of the ejector type, or of the type referred to as a “gas lift” which is derived from the conventional term “airlift” and which expresses the fact that the driving fluid may be other than air

Ejector and gas lift are two types of DELG which are distinguished by the following points:
an ejector is supplied with a driving fluid under a pressure substantially higher than that of the liquid to be driven and comprises a venturi tube through which this liquid is sucked; on the one hand, the depression in the venturi tube causes the suction of the liquid and, on the other hand, the kinetic energy of the fluid and the difference in specific gravity cause it to rise,
a gas lift is supplied with a driving fluid which has a pressure only very slightly higher than that of the liquid to be driven and which is introduced directly, simply by “bubbling”, into the latter; it is the conjunction of the Archimedes force and the viscous interaction forces between the driving fluid and the liquid which causes the liquid to be driven and to rise.

Unlike pumps, these DELGs do not include any rotating parts and are therefore particularly suitable for the device according to the invention, given the very hostile conditions prevailing in molten media.

The first injection device 205 is actuated by the first driving fluid and ensures both the suction of the liquid through the first inlet 206 and its lifting in the first conduit 201.

The liquid to be driven is thus moved by the first driving fluid introduced into the ascending first conduit 201 containing said liquid. The Archimedes force, which causes the first driving fluid to rise in the first conduit 201 and the viscous interaction forces between the first driving fluid and the liquid, cause the liquid to be driven and to rise.

The first injection device 205 creates an emulsion between the first driving fluid and the liquid moved in the first conduit 201, and therefore intimate contact between these two phases for the duration of their movement.

The first driving fluid is for example air, or any other gas rich in oxygen.

The oxidation loop 200 further comprises a first separation device 208, connected to the end of the first conduit 201 opposite the first inlet 202.

The first separation device 208 is of “separator pot” type and comprises an inlet 209 for the liquid circulating in the first conduit 201, a vent 210 for a separated gaseous effluent 211, and a discharge conduit 213 for the separated liquid 214, the end 216 of which opens into the tank 100, preferably immersed in the liquid 101.

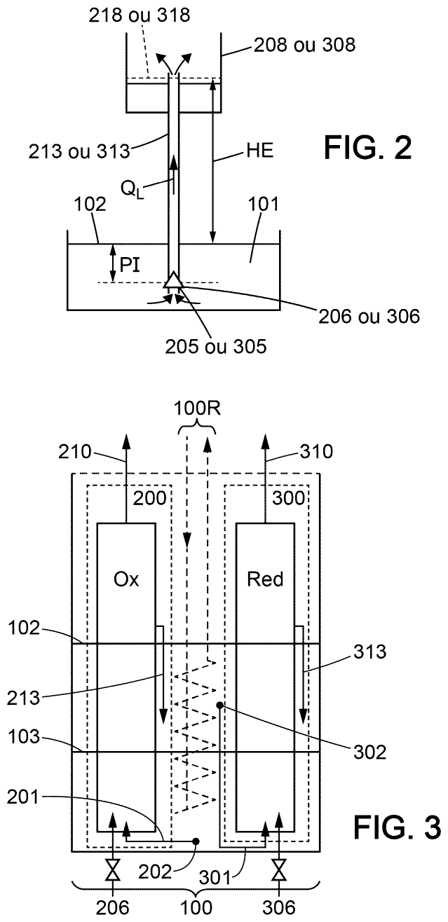

FIG. 2 schematically illustrates the hydraulic operation of the assembly formed in particular by the first injection device which is actuated by the first driving fluid 206 via the DELG 205 and the first separation device which uses the separator pot 208; the terms PI, QL and HE which appear in this figure are explained below in the description.

The oxidation loop 200 therefore implements looping of the liquid loaded with reducing agent, that is to say a closed circuit movement of this liquid which leaves the tank 100 through the first inlet 202, travels through the oxidation loop 200 and returns to the tank 100 via the discharge conduit 213.

In parallel, the reduction loop 300 comprises a second conduit 301 which has, for example, a serpentine shape.

The second conduit 301 has a second liquid inlet 302 opening into the tank 100. When the liquid is two-phase (case of FIG. 1), it is located in the phase rich in oxidizing agent.

At an injection point 304, the second conduit 301 comprises a second injection device 305, which comprises an inlet 306 for a second driving fluid comprising fuel, which is delivered by a second valve 307.

The second injection device 305 is also of DELG type, as defined above.

Note that this second driving fluid may be not only a gas (for example natural gas) but also a liquid (for example a heavy fuel oil), or even a solid (for example coal), in which cases the driving processes and the rise of the liquid are ensured by the vapors made up of the volatile compounds that these fluids generate in contact with the hot liquid.

The reduction loop 300 also comprises a second separation device 308, of “separator pot” type, which comprises an inlet 309 for the liquid circulating in the second conduit 302, a vent 310 for discharging a separated gaseous effluent 311, and a discharge conduit 313 for the separated liquid 314, one end 316 of which opens into the tank 100, preferably immersed in the liquid 101.

The hydraulic operation of the assembly formed by the second injection device which is actuated by the first driving fluid 306 via the DELG 305 and the second separation device which uses the separator pot 308, is also shown in FIG. 2.

The operation of the elements of the reduction loop 300 is similar to that of the oxidation loop 200.

There is therefore also looping of the liquid rich in oxidizing agent, that is to say a closed circuit movement of this liquid, which leaves the tank 100 through the second inlet 302, travels through the reduction loop 300 and returns to the tank 100 via the discharge conduit 313.

Advantageously, the oxidation loop 200 and the reduction loop 300 are “rapid circulation” loops, that is to say they have the two features described below.

First of all, the first and second separation devices 208, 308 are “rapid discharge” devices, which means that they do not experience clogging even when the driven liquid is at significant flow rates “Q_{L}”. To this end, the first and second discharge conduits 213, 313 have passage sections large enough that the liquid which descends therein undergoes negligible pressure loss.

The first and second separation devices 208, 308 are also installed in the combustion device at respective heights such that, when the combustion device is stopped, levels 218, 318 of liquid respectively in the oxidation loop 200 and the reduction loop 300 are established within the first and second separation devices 208, 308 themselves, or at a position located slightly below these separation devices 208, 308. This means, for example, that the position of the levels 218, 318 is at a distance below the respective inlets 209, 309 of the separation devices 208, 308, which does not exceed, for example, 30% of an immersion depth, denoted PI in FIG. 2, at which the injection devices 205, 305 are immersed in the first and second conduits 201, 301 respectively.

These two design aspects of the first and second separation devices 208, 308 ensure that, when the injection devices 205, 305 are in operation, the liquid levels 218, 318 are established at a height which is practically constant and substantially equal to or barely above the height of the free surface 102 of the liquid in the tank 100.

This means that, for example regarding the oxidation loop 200, the height of elevation, denoted HE in FIG. 2, of the injection device 205, which is defined as the difference between the liquid levels in the tank 102 and in the separation device 218, is practically zero. Consequently, the circulation of the liquid within the oxidation loop 200 takes place practically without change in altitude of the liquid and therefore without effective mechanical effort: all the mechanical energy provided by the first driving fluid is thus used to circulate the liquid, that is to say to overcome the internal viscosity forces and friction forces on the walls. The speed of circulation of the liquid is therefore independent of its specific gravity, which is very important because molten metals and oxides have high specific gravities. It therefore follows from these two design aspects that the circulation of the liquid is rapid.

By virtue of this rapid circulation, the reducing agent is, in this oxidation loop 200, in large excess with respect to the air contained in the first driving fluid, with regard to the stoichiometry of the oxidation reaction. In other words, the molar ratio (M/O₂) of the oxidation reaction (1) is greater than the stoichiometric ratio.

The same observation and the same reasoning apply to the reduction loop 300: the oxidizing agent performs rapid rotations in this loop and is in large excess therein with respect to the fuel, with regard to the stoichiometry of the reduction reaction (2).

These conditions of strong excess of the molar flow rates of the oxidizing and reducing agents relative to their respective driving fluids mean that, in the oxidation loop 200, the oxygen in the air is practically entirely consumed by the reducing agent and in the reduction loop 300, the fuel is practically entirely consumed by the oxidizing agent.

Because the liquid levels 218, 318 are virtually constant, regardless of the operating speed of the combustion device and any variations in this speed, the liquids present in the separation devices 208, 308 are prevented from rising in the vents 210, 310 for the gaseous effluents, which would be undesirable.

Preferably, the combustion device has one or more of the following additional features:
at least one of the separation devices 208, 308 comprises a mist eliminator 215, 315, for example of baffle or packed type, which rids the gaseous effluent of any liquid droplets,
the valves 207, 307 are located above the liquid level 102 in the tank 100,
the vent 210 of the first separation device 208 is equipped with an oxygen analyzer 212, and
the vent 310 of the second separation device 308 is equipped with a CO2, CO or unburned hydrocarbon analyzer 312.

Optionally, the combustion device may comprise several oxidation and/or reduction loops, several injection devices connected to the same or to several separation devices.

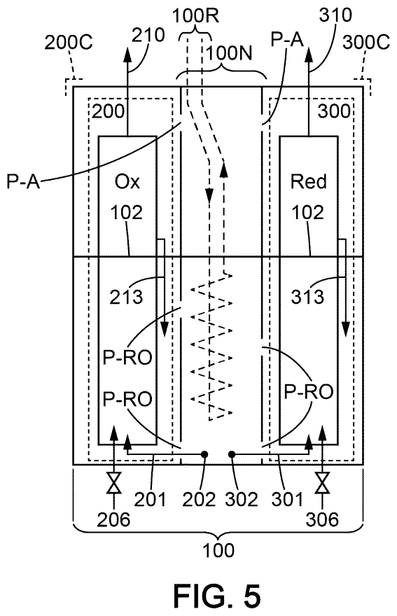

The tank may include one or more circuits 100R intended to recover heat contained in the liquid with, as thermal fluid, water, steam or another fluid. This option is shown in FIGS. 3 and 5.

A method for combustion in liquid medium according to the invention, using the combustion device described above, is now described. This method includes the following steps, in no specific order.

Using the first injection device 205 injecting air as the first driving fluid 206, liquid is taken in through the first inlet 202 and this liquid is lifted, forming an emulsion 217 with the air, in the first conduit 201 up to the first separation device 208.

Within the first separation device 208, this emulsion 217 is separated into a gaseous effluent 211 comprising mainly N₂, which is extracted through the vent 210, and a liquid phase 214 which is discharged via the discharge conduit 213 and which is thus returned to the tank 100.

Thus, on the one hand, the reaction of oxidation of the reducing agent by air, which occurs in the first conduit 201 then in the first separation device 208, generates oxidizing agent which is found, with the reducing agent in excess, in the liquid 214. This liquid descends in the discharge conduit 213 and is discharged at a point 216 from which said reducing and oxidizing agents are reincorporated into the liquid. If the liquid is single-phase, the reducing agent and the oxidizing agent are incorporated directly into the liquid, and if the liquid is two-phase, the reducing agent and the oxidizing agent migrate, owing to the difference in specific gravity, toward their respective phases, which completes their looping process.

On the other hand, the air, which has lost all or almost all of its oxygen, is in the form of gaseous effluent 211 rich in N₂ in the vent 210 through which it is discharged from the oxidation loop 200.

By means of the second injection device 305 injecting fuel 306 as the second driving fluid, liquid is taken in via the second inlet 302 and this liquid is lifted, forming an emulsion 317 with the fuel, in the second conduit 301 up to the second separation device 308.

Within the second separation device 308, this emulsion 317 is separated into a gaseous effluent 311 comprising mainly CO₂ and H₂O, which is extracted through the vent 310, and a liquid phase 314 which is discharged via the discharge conduit 313 and which is thus returned to the tank 100.

Thus, on the one hand, the reaction of reduction of the oxidizing agent by the fuel, which occurs in the second conduit 301 then in the second separation device 308, generates reducing agent which is found, with the oxidizing agent in excess, in the liquid 314. This liquid descends in the discharge conduit 313 and is discharged at a point 316 from which said reducing and oxidizing agents are reincorporated into the liquid. If the liquid is single-phase, the reducing agent and the oxidizing agent are incorporated directly into the liquid and if the liquid is two-phase, the reducing agent and the oxidizing agent migrate, owing to the difference in specific gravity, toward their respective phases, which completes their looping process.

On the other hand, the fuel, which has been entirely or almost entirely oxidized by the excess of oxidizing agent, is in the form of gaseous effluent 311 comprising CO₂ and H₂O in the vent 310 through which it is discharged from the reduction loop 300.

The combination of these two looping processes therefore means that the reducing and oxidizing agents are first consumed then regenerated according to their speeds of rotation in their respective loop 200, 300 and return to the liquid. There is therefore “spatial looping” of both the reducing agent and the oxidizing agent, these loops starting from the liquid 101, passing respectively through the separation devices 208 and 308 and returning to the liquid.

In the method according to the invention, the injection devices 205, 305 thus have the dual function of lifting the reducing and oxidizing agents and ensuring the oxidation and reduction reactions within the emulsions 217, 317.

The first injection device 205 may, in addition to air, use nitrogen or water vapor as the first driving fluid, but not CO₂, while the second injection device 305 may, in addition to fuel, use CO₂ or water vapor as driving fluid, but not air or oxygen.

To obtain continuous operation of the method according to the invention, the rates of consumption and regeneration of the reducing and oxidizing agents in the oxidation and reduction loops should be balanced to prevent depletion of one of them within the liquid. To this end, it is sufficient to impose flow rates of air and fuel which are “essentially proportional” to one another, which means that the ratio between the molar flow rates of oxygen and fuel is taken equal to the stoichiometric molar ratio of fuel/oxygen of reaction (3), this ratio being equal to 2 in the case of methane. Reactions (1) and (2) then progress generally at essentially equal speeds, each of the reagents being consumed at the same rate as it is produced.

It follows that the concentrations of reducing agent and oxidizing agent in the liquid 101 are static and that the volume of the liquid is constant, as is that of the phases of the liquid when it is two-phase.

### Different Types of the Tank

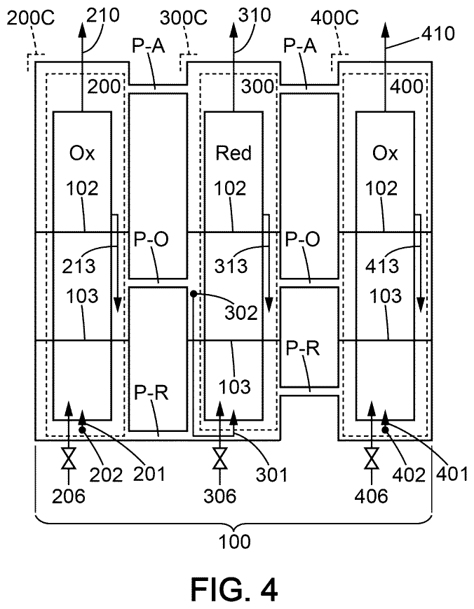

According to a second embodiment, shown in FIG. 4, the tank 100 may be formed of a plurality of compartments in communication with one another.

In the example of FIG. 4, the tank 100 comprises three separate compartments.

In this case, at least one of the compartments contains an oxidation loop 200 and at least one of the compartments contains a reduction loop 300.

In the example of FIG. 4, the combustion device comprises two oxidation loops Ox and one reduction loop Red, contained in distinct respective compartments.

To ensure continuity of the liquid and the balance between the liquid levels, the liquid phases contained in the different compartments of the tank 100 are placed in communication with one another.

In the case of a two-phase liquid shown in FIG. 4, this communication is ensured both by hydraulic bridges P-R between the phases rich in reducing agent and hydraulic bridges P-O between the phases rich in oxidizing agent.

The hydraulic bridges P-R, P-O are, for example, pipes.

This dual “hydraulic bridging” between compartments creates a dual effect of communicating vessels and produces the following remarkable effect, which results from the combined laws of gravity and hydraulics: when a certain quantity of reducing agent (respectively oxidizing agent) is created by reaction in a given compartment, it is distributed spontaneously and uniformly in all the compartments via the hydraulic bridges P-R (respectively the hydraulic bridges P-O): the liquid levels 102 and 103 in the compartments therefore remain identical.

This ensures spatial looping, according to the definition given above, of the oxidizing and reducing agents between the compartments. The atmospheres of the compartments are also in communication with one another by bridges P-A, the joining of these atmospheres forming the “tank atmosphere”.

In order to force circulation between compartments and thus maximize the uniformity of composition and temperature of the liquid in the different compartments, the suction points 202, 302 and return points 214, 314 for the liquid may be located in distinct compartments.

The advantage of a poly-compartment tank is to allow additional separation between the loops, which further reinforces operational safety, the loops already being gastight in themselves. In a third embodiment shown in FIG. 5, the tank 100 comprises three compartments adjoining one another and separated by internal walls.

In the example in FIG. 5, the liquid is single-phase. Communication between the compartments is ensured by hydraulic bridges P-RO, which create an effect of communicating vessels between all the compartments.

The hydraulic bridges are, for example, holes in the walls between compartments.

In the example in FIG. 5, one of the compartments 100N contains neither an oxidation loop nor a reduction loop.

This makes it possible, for example, to build up a reserve of liquid and accommodate a heat recovery circuit 100R.

This also makes it possible, in the case of a two-phase liquid (not shown), to receive the liquid returns 216, 316 and allow good separation, by a calming effect, of the liquid phases discharged in these returns 216, 316.

The methods of using combustion devices according to the second and third embodiments presented here are identical to the method described above, except that the balancing of air and fuel flow rates to ensure continuous operation must take into account the sum of the flow rates in the oxidation loops and the sum of the flow rates in the reduction loops. It is therefore these overall flow rates which must be proportional to one another to ensure static operation.

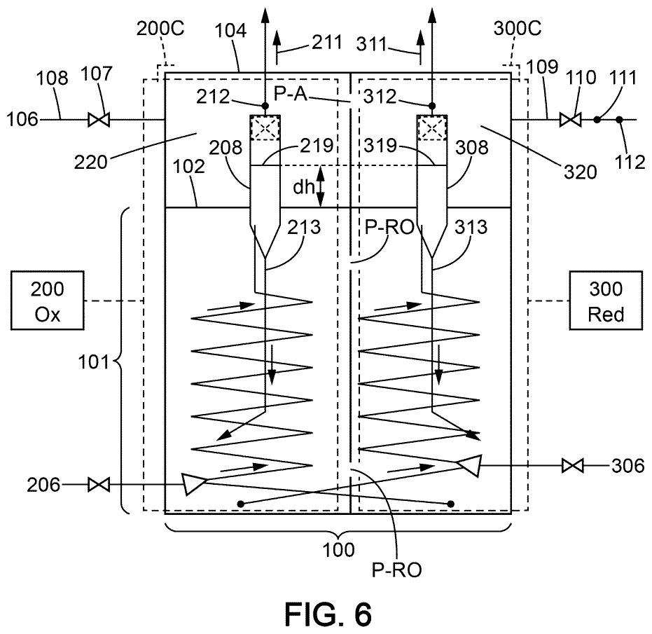

In a fourth embodiment shown in FIG. 6, compatible with both a single-phase and a two-phase liquid, the atmosphere of the tank 100 is conditioned using an inert gas. It is referred to as an inerted tank.

For this purpose, the atmosphere of the tank is connected to a circuit 106 for supplying inert gas such as water vapor or nitrogen. This inert gas circuit 106 comprises a conduit 108 which brings said inert gas to the tank 100 and which is provided with a valve 107 for the intake of this gas and a conduit 109 which extracts said inert gas from the tank 100 and which is provided with a valve 110.

In the case of a tank with several compartments, the bridges P-A make it possible to equalize the pressures of the atmospheres of the various compartments.

Preferably, the inerting circuit 106 also comprises one or more CO₂, CO or hydrocarbon detector(s) 111 and one or more O₂ detector(s) 112 which are preferably installed downstream of the valve 110 but may also be, for example, at various bridges P-A.

The method of using the combustion device according to this fourth embodiment comprises the steps described above, as well as a step of flushing the atmosphere of the compartment(s) of the tank 100 with the inert gas.

Preferably, the appearance of any gas leaks from the oxidation loops is monitored using the O₂ detector 112 and any leaks from the reduction loops using the detector 111.

Also preferably, the method comprises an additional operation consisting in pressurizing the tank 100, for example by partially closing the valve 110, such that the pressure of the atmosphere of the tank 100 exceeds, for example by a few decibar, the pressures prevailing in the separator pots 208 and 308.

The creation of this excess pressure has two favorable effects. First, it further reduces the risk of leakage of gaseous effluents (in particular CO₂/H₂O effluent which may contain traces of hydrocarbons) from the loops into the atmosphere of the compartment or tank. In addition, it causes a rise in the liquids in the separation devices 208, 308 from levels 218, 318 to levels 219, 319, without increasing the load on the injection devices. Due to this increased height of these two levels, the volumes of the two gas/liquid emulsions in the separation devices 208, 308 increase, and their residence time in these pots are therefore increased, which promotes the completion of the respective reactions.

### Operation Under Pressure

In a fifth embodiment of the invention, the entire device, in other words the atmosphere of the tank, the liquid it contains and consequently the fluids supplied to it, is maintained at a pressure higher than the pressure prevailing “outside the device”, that is to say beyond the vents 210 and 310 respectively.

The pressure level that may be used in this fifth embodiment is substantially higher than that of the overpressure between the tank and the separator pots 208 and 308, as described above, and may reach several bar or even several tens of bar. This measure makes it possible to minimize the volume of the gases used and consequently the volume and floor space of the facility. Another positive effect is that the gaseous effluents rich in N₂ and in CO₂/H₂O are then available under pressure at the vents 210 and 310 and may produce mechanical or electrical energy by driving, for example, an expansion turbine.

The devices and methods for combustion in liquid medium according to the invention offer the following advantages compared to existing techniques.

In terms of simplicity, continuous operation is particularly simple since all that is required is to impose air and fuel flow rates which are essentially proportional to one another. In addition, it is possible to ensure the production of continuous and constant thermal power by simply choosing a fuel flow rate corresponding to this power and taking in an air flow rate proportional thereto.

In terms of safety, the oxidation loop 200 and reduction loop 300 constitute separate and gastight circuits. An oxidation loop and a reduction loop may be installed in the same tank 100. In this device, the effluent N₂ present in the first separation device 208 cannot descend into the discharge conduit 213 and flow back toward the liquid, because this conduit acts as a hydraulic guard. The driving gas from the first injection device 205 cannot descend into the liquid through the first inlet 202 because the gas jet is oriented upward and the Archimedes force also drives it upward. For the same reason, there is no risk of reflux of the CO₂/H₂O effluent, or of the fuel toward the liquid.

In terms of efficiency, the air and fuel flow rates must correspond to the target thermal power. This is required to ensure continuous operation of the device at said power. To achieve this condition, using the valves 207, 307, the flow rates of supply of driving fluids to the injection devices 205, 305 will be adjusted according to the target power and the type of injection devices (gas lift or ejector) used. The fuel flow rate, which determines the desired thermal power, will be set first, followed by the air flow rate in proportion.

In addition, the contact between each driving fluid and the corresponding oxidizing or reducing agent must be sufficiently intimate and long for the kinetics of the two reactions to be rapid. By choosing an injection device 205, 305 either of gas lift type or of ejector type, and by adapting their geometry, it is possible to obtain fluid bubbles and therefore emulsions which are fine to a greater or lesser degree. Furthermore, by modifying the length of the conduits 201, 301 and the volumes of the separation devices 208, 308, it is possible to modulate the gas/liquid contact times as a function of the chemical reactivity between air and reducing agent, respectively between fuel and oxidizing agent.

The dual looping of the liquid must be rapid, this being necessary to ensure the excess of reducing agent and oxidizing agent respectively in relation to the air and the fuel and to keep a uniform temperature within the liquid. To be specific, as the heats from the oxidation and reduction reactions are a priori different, the temperatures of the liquids at the outlets 216, 316 of the loops may be very different and create compositional heterogeneities or even undesirable hot spots within the liquid. To achieve this condition, the two loops are “rapid circulation” loops as described above, the convection movements and the turbulence caused by these rapid circulations ensuring homogenization of the liquid. In the case of viscous liquids, that is to say with a viscosity greater than 50 cSt (centistokes) for example, an ejector will be chosen rather than a gas lift and preferably an ejector having a venturi geometry which ensures a strong liquid suction depression.

In terms of reliability in continuous operation, owing to their fully hydraulic operating mode, the injection devices do not include any rotating parts likely to wear or break in a “hostile” medium, which is a key factor as regards reliability.

Since, in continuous operation, the overall volume of the liquid remains constant (as does that of the reducing and oxidizing phases when the liquid is two-phase), the levels of the liquids in the tank are constant and the issue of “managing” them therefore does not arise.

Because these levels are constant and thanks to the use of rapid discharge pots, each of the injection devices 205, 305 operates both at a constant immersion depth (denoted “PI” in FIG. 2) and at a substantially constant and low elevation height (denoted HE in FIG. 2). Their operation is therefore stable and their respective hydraulic efficiency is optimal.

By using, in a preferential manner, an O₂ analyzer 212 and a CO₂, CO or unburned fuel analyzer 312, it is possible to monitor correct progress of the oxidation and reduction reactions.

In terms of flexibility, the two loops may operate independently of one another, for example at start-up, for admittedly limited durations, with different speeds of circulation of the two oxidizing and reducing agents, conditioned by the respective settings of the injection devices 205, 305.

### Redox Couples and Liquid Media

A definition of “(M, MO)” type of the redox couples was given at the beginning of the description by way of illustration. This formulation may in fact be expanded as follows:
the reducing agents R derive from “precursor metals” denoted “M” and have the generic formula that is no longer M, but, more broadly, MₓO_{y} in which “y” may be zero (which corresponds to the case where R is a metal, with, as an example, R═Cu)
the oxidizing agents O have the same precursor metal M but have the generic formula M_{x′}O_{y′}, with 0≤y/x<y′/x′. For example, when O═CuO, then x′=y′=1.

To sum up, the generalized formulation of the redox couple is characterized by the fact that, in the molecule of the reducing agent R, M has a lower degree of oxidation than in the molecule of the oxidizing agent O.

The formulation of the liquid medium may also be generalized as follows:

The R or O agent may be associated with one or more auxiliary agents which may be a flux or an oxidation catalyst such as Ag, Au, Pt in low contents. Incidentally, such a catalyst could be included, at low concentration, in all liquid compositions.

Furthermore, within the liquid, each of the R and O agents may be present either entirely or essentially in the liquid state (that is to say in the molten state), or entirely or essentially in the form of dispersed solid fine particles, or simultaneously in the liquid state and in the form of dispersed fine particles.

In the latter two cases, the applicant has determined that it is advantageous to use particles of R or O agent of micrometric or better still nanometric size (“nanoparticles”) so that their suspensions in the liquid are very stable. The stability of these suspensions is favored by the turbulence resulting from the movement of the liquid in the rapid circulation loops and the bubbling of the gases, this turbulence being inherent in the method according to the invention. It may also be enhanced by external stirring of the liquid (ultrasonic agitator, bubbling of an inert gas, etc.).

Note also that, in processes of generating particles of reducing or oxidizing agent, these particles are very fine when they are created and, as they are constantly consumed by the action of redox reactions, their lifespan, which is very limited in the liquid, vastly reduces their crystalline growth and their size, which reduces their risk of separation from the liquid in which they are in suspension.

### Formulation of Two-Phase Liquid Media

The applicant has identified a number of interesting series of two-phase liquids in which the reducing agent R, whether or not associated with fluxing agents, is in completely liquid form, while the oxidizing agent O may be either entirely or essentially in the liquid state, or simultaneously in the liquid state and in the form of dispersed particles, or essentially in the form of dispersed particles.

These various formulations are described below.

A) O agent entirely or essentially in the liquid state:

In such a series, the O agent is entirely or essentially in the liquid state. The term “essentially” in this case expresses the fact that during the redox reactions, dispersed fine particles may appear in low concentrations as a result of the solubility product of O being slight exceeded; however, there is no external addition of solid O particles.

The following three individual cases are interesting.

A1) Two-phase liquid media based on tin

The liquid in this case comprises:
as R agent, the metal Sn (Tm=231° C.) with, as possible flux, bismuth, lead, or bismuth and lead
as O agent, the oxide SnO or SnO₂ (Tm=1045° C.) with, as possible flux, SiO₂, M(I)₂O (M(I) designating in this document an alkali metal), V₂O₅ or indeed MoO₃, whether or not associated with M(I)₂O.

A2) Two-phase liquid media based on bismuth

The liquid in this case comprises:
as R agent, the metal Bi (Tm=271° C.)
as O agent, the oxide Bi₂O₃ (Tm=817° C.) with, as possible flux, B₂O₃, PbO, PbO and B₂O₃ associated, ZnO or indeed ZnO and B₂O₃.

A3) Two-phase liquid media based on lead

The liquid in this case comprises:
as R agent, the metal Pb (Pb; Tm=327° C.) with, as possible flux, bismuth
as O agent, the oxide PbO (Tm=888° C.) with, as possible flux, V₂O₅, B₂O₃, SiO₂ or MoO₃

B) O agent simultaneously in the liquid state and in the form of dispersed particles

In this second series of two-phase liquids, new liquids are prepared from the compositions defined in paragraphs A1-A3 by adding thereto O agent in the form of dispersed fine particles. For example, fine particles of tin oxide SnO₂ may be added to and dispersed in the eutectic mixture SnO₂—SiO₂ defined in paragraph A1.

C) O agent essentially in the form of dispersed fine particles

The two-phase liquids of this third series may be prepared as follows.

As liquid substrate, use will be made of a “meltable mixture” which is a mixture of third-party salts or oxides not having redox properties in themselves and having a relatively low melting point, for example below 520° C. Once this meltable mixture is molten, O agent will be added in the form of fine particles which will form a stable dispersion therein. The term “essentially” in this case expresses the fact that, in general, a minor fraction of these fine particles will dissolve in the molten meltable mixture. The following will advantageously be used as meltable mixtures: compositions identical to, or close to, eutectics and for example, binary eutectic salts containing the cation pairs Na⁺—K⁺, Na⁺1'Li⁺ or K⁺—Li⁺ or ternary eutectic salts containing the triplet Na⁺—K⁺—Li^{—}. The anions associated with these cations will mainly be carbonate, sulfate, borate, vanadate, chromate, molybdate or tungstate anions or several of these anions.

By way of example, two-phase liquids may be prepared which will have the following ternary “meltable mixtures” as liquid substrates:
Na₂CO₃—Li₂CO₃—K₂CO₃ with a ternary eutectic melting at Tm=390° C.
Na₂SO₄—Li₂SO₄—K₂SO₄ with a ternary eutectic melting at Tm=512° C.
Na₂SO₄—K₂SO₄—ZnSO₄ with a ternary eutectic melting at Tm=420° C.
NaVO₃—KVO₃—LiVO₃ with a ternary eutectic melting at Tm≈400° C.
Na₂MoO₄—Li₂MoO₄—K₂MoO₄ with a ternary eutectic melting at Tm≈380° C.
Na₂WO₄—Li₂WO₄—K₂WO₄ with a ternary eutectic melting at Tm=425° C.
Na₂CrO₄—Li₂CrO₄—K₂CrO₄ with a ternary eutectic melting at Tm<320° C.

To be concise, the two-phase liquids according to the invention belong to the following series:
either the R agent is constituted by Sn, whether or not associated with a flux: Bi, Pb or Sb while the O agent is constituted by SnO2 or SnO, whether or not associated with a flux: SiO₂, V₂O₅, B₂O₃, MoO₃ or MA2O, MA designating an alkali metal
or the R agent is constituted by Bi while the O agent is constituted by Bi₂O₃, whether or not associated with a flux: ZnO, B₂O₃ or PbO
or the R agent is constituted by Pb whether or not associated with the flux Bi, while the O agent is constituted by PbO whether or not associated with a flux: SiO₂, V₂O₅, MoO₃ or B₂O₃ or MA₂O, knowing that:
the molten R agent may be associated with an oxidation catalyst such as Au, Ag or Pt,
the O agent is present either entirely or essentially in the liquid state, that is to say with a zero or minor fraction of this oxide in the form of dispersed fine particles, or simultaneously in the liquid state and in the form of dispersed fine particles, or essentially in the form of fine particles dispersed in a meltable mixture which constitutes the liquid substrate of the O phase and which comprises alkaline cations and one or more anions chosen from the group: carbonate, sulfate, borate, vanadate, chromate, molybdate, tungstate anion.

### Formulation of Single-Phase Liquid Media

The applicant has also identified three possible types of single-phase liquid formulations, in which the R agent, whether or not associated with fluxing agents, is entirely or essentially in the liquid state, while the O and R agents may be either entirely or essentially liquid, or simultaneously in the liquid state and in the form of dispersed particles, or even essentially in the form of dispersed particles, as explained below.

A) O and R agents entirely or essentially in the liquid state

In this first series of single-phase liquids, the R and O agents are molten, with however one or the other possibly slightly exceeding its solubility limit in the liquid during the redox reactions. The O agent may comprise a metal with a high degree of oxidation Fe(III), Cu(II), Ni(II), V(V), Cr(VI), Mo(VI), W(VI), Ce(IV), the associated R agent being this metal with a lower degree of oxidation, such as: Fe(II), Cu(I) or Cu(0), Ni(0), V(IV), Cr(V), Mo(IV), W(IV), Ce(III), “M(0)” designating the metallic form of M.

In general, the R and O agents are rendered meltable using one or more flux(es) comprising alkali metal or transition metal oxides.

The liquid may be one of the following examples.

A1) A mixture MoO3-MoO2-M(I)′2O.

M(I)′ represents an alkali metal or a mixture of alkali metals. In this case, the O agent is Mo(VI) in the form of MoO₃ while the R agent is Mo(IV) in the form of MoO₂, which results from the reduction of MoO₃ by the fuel. The alkaline oxide M(I)′₂O plays the role of flux.

A2) A mixture, on the one hand, of V₂O₅ and K₂O in a molar ratio V₂O₅/K₂O close to ⅔ (Tm=382° C.) and, on the other hand, of carbonates or sulfates of copper, iron, nickel, vanadium, molybdenum, tungsten or cerium.

The R agent is in this case Cu(II), Fe(III), Ni(II), V(V), Cr(VI), Mo(VI), W(VI) or Ce(IV) while the O agent is Cu(I) or Cu(0), Fe(II), Ni(0), V(IV), Cr(III), Mo(IV), W(IV) or Ce(III), which result from the reduction of the cations of the same metals.

A3) A mixture CuO—V₂O₅.

The O agent is Cu(II) and the R agent is Cu(I) or Cu(0).

A4) A mixture NiO—V₂O₅—K₂O or CuO—V₂O₅—K₂O.

The O agent is M(II) and the R agent is Ni(0) or indeed Cu(I) or Cu(0).

A5) A mixture CuO—MoO₃.

The O agent is Cu(II) or Mo(VI) and the R agent is, depending on the thermal conditions: Cu(I), Cu(0), Mo(IV) or Mo(V).

A6) A mixture CeO₂—MoO₃.

The O agent is Ce(IV) or Mo(VI) and the R agent is Ce(III), Mo(IV) or Mo(V).

A7) A mixture Fe₂O₃—V₂O₅.

The O agent is Fe(III) or V(V) and the R agent is Fe(II) or V(IV).

A8) A mixture Fe₂O₃—V₂O₅—MoO₃.

The O agent is Fe(III), V(V) or Mo(VI) and the R agent is Fe(II), V(IV), Mo(IV) or Mo(V).

A9) A mixture Cr₂O₃—Na₂O—V₂O₅.

The O agent is V(V) and the R agent is V(IV).

A10) A mixture Cr₂O₃—V₂O₅—MoO₃.

The O agent is V(V) or Mo(VI); the R agent is V(IV) or Mo(IV).

A11) A mixture WO₃—Na₂O—V₂O₅.

The O agent is W(VI) or V(V) and the R agent is W(IV) or V(IV).

B) O or R agent simultaneously in the liquid state and in the form of dispersed fine particles

In this second series of single-phase liquids, new compositions may be prepared by deliberately adding, to one of the above compositions A1 to A11, an R or O agent which will be in the form of dispersed fine particles. For example, fine particles of Cu₂O (R agent) and/or CuO(O agent) could be added to the mixture CuO—V₂O₅ defined in paragraph A3. The R and/or O agent will thus be both in the liquid state and in the form of dispersed fine particles.

C) O and/or R agents essentially in the form of dispersed fine particles

In this third series of single-phase liquids, the starting mixture will be one of the “meltable mixtures” described above, which will constitute the liquid substrate and into which the R or O agent, or both, in the form of dispersed fine particles will be incorporated, a minor fraction of the latter possibly dissolving in this liquid. The same redox couples as in paragraph A may be used, namely:
R agents: Cu(I) or (0); Fe(II) or (0); Ni(0); Cr(III); V(IV); Mo(IV); W(IV); Ce(III),
associated O agents: Cu(II); Fe(III); Ni(II); Cr(VI); V(V); Mo(VI); W(VI); Ce(IV).

To be concise, the single-phase liquids according to the invention belong to the following series:
the R agent comprises at least one body of formula “MₓO_{y}”, M designating a transition metal belonging to the group: Cu; Fe; Ni; Cr; Mo; W; V; Ce and the number “y” may be zero,
the O agent comprises at least one oxide of formula “M_{x′}O_{y′}”, the ratio (y′/x′) being strictly greater than the ratio (y/x) with, therefore: (y′/x′)>(y/x)≥0,
the liquid medium optionally comprises one or more flux(es) of formula MFaOb, MF being a metal distinct from M and chosen from the group: alkali metals; V; Mo; Cr; W,

knowing that:
the R agent may be associated with an oxidation catalyst such as Au, Ag, Pt,
each of the O and R agents is present either totally or essentially in the liquid state, or simultaneously in the liquid state and in the form of dispersed fine particles, or essentially in the form of fine particles dispersed in a meltable mixture which is the liquid substrate of the liquid and which comprises alkaline cations and one or more anions chosen from the group: carbonate, sulfate, borate, vanadate, chromate, molybdate, tungstate.

### Agents in the Form of Nanoparticles

As some of the above formulations use R or O agents in the form of fine particles and in particular nanoparticles, it is interesting, by way of illustration, to give two methods of preparing the latter.

A) Nanoparticles formed via “polyol” synthesis:

This type of synthesis uses as starting product a compound of the metal M which is the precursor compound of the R and O agents. It may in particular be an inorganic salt, a carboxylate or a hydroxide of the metal M. It is dissolved or dispersed finely in a polyol, for example in a diol, in particular in ethylene glycol. To this polyol, a capping agent, which is an organic molecule which stabilizes the nanoparticles by being adsorbed strongly on them, may possibly be added. Examples of such capping agents are citrates, polyvinyl pyrrolidone (PVP), polyvinyl alcohols (PVA), oligo- or polysaccharides, carboxymethylcellulose, oleic acid, oleylamine, etc. For the preparation of the R agent, a reducing agent “X”, which may be hydrazine or hydroxylamine, will be added to this polyol. The mixture is heated and maintained near the boiling temperature of glycol. Submicronic and generally nanometric particles are thus obtained, the size of which depends on the thermal conditions, and on the concentration of precursor compound and of capping agent, where applicable. These nanoparticles consist either of R agent in the presence of the reducing agent X, or of O agent in the absence of agent X. These particles are separated from the mixture by filtration. This polyol preparation method is illustrated below in the second example.

B) Nanoparticles formed via “thermolysis of a salt”:

Thermolysis is carried out, that is to say the thermal decomposition of a precursor salt of the metal M, this salt preferably being a carboxylate of M or a dicarboxylate of M, comprising an oxalate, a malonate, a succinate or a glutarate. This precursor salt may or may not have an added capping agent such as oleic acid or oleylamine. Thermolysis generates particles of R or O agent, depending on whether the redox conditions are either reducing, or neutral or oxidizing. The size of these particles, generally nanometric, depends on the temperature and on the initial concentration of precursor salt and of capping agent, where applicable. These particles are separated from the mixture.

### First Embodiment

The fuel is natural gas likened to methane (PCI: 802 KJ/mol) and the redox couple is made up of:
reducing agent R, which is metallic bismuth Bi(O), with a melting point Tm equal to 271° C., with an atomic mass of 209 g/mol and with a specific gravity of 9.5, and,
oxidizing agent O, which is bismuth trioxide (Bi2O3) associated with the flux B2O3 in the form of the eutectic 80% Bi2O3-20% B2O3 (Tm: 620° C.; molar mass 386.7 g/mol; specific gravity substantially equal to 77).

The liquid is therefore two-phase and the R and O agents are of the fully molten type, the R phase being liquid bismuth and the O phase being the eutectic Bi₂O₃—B₂O₃ which will also be referred to as “bismuth borate” below.

The redox reactions are:

reduction: 8/3Bi+2(O₂+kN₂)→4/3Bi₂O₃+2kN₂ (4)

oxidation: CH₄+4/3Bi₂O₃→CO₂+2H₂O+8/3Bi (5)

These two reactions balance out as the abovementioned reaction (3), methane combustion reaction.

The molar stoichiometric ratio of the oxidation reaction “Ros” (Bi/O₂) is (8/3)/2=1.33 (reaction (4)).

The molar stoichiometric ratio of the reduction reaction “Rrs” (Bi₂O3/CH4) is 4/3, i.e. also 1.33(reaction (5)).

The molar stoichiometric combustion ratio “Rcs” (O₂/CH₄) is 2 (reaction (3)).

The target is a thermal power of 80 kW, i.e. a CH₄ consumption of 80/802≈ 0.1 mol/s (mole per second).

Since the molar stoichiometric ratio Rcs (O2/CH4) is 2, the stoichiometric consumption of oxygen is 2×0.1=0.2 mol/s and that of air is 0.2*(1+k)=0.2*4.76=0.952 mol/s.

Since the molar stoichiometric ratio of the oxidation reaction Ros (Bi/O2) is 1.33, the stoichiometric consumption of Bi is 1.33×0.2=0.266 mol/s, i.e. 55.6 g Bi/s, or barely 5.9 cm³/s of liquid Bi, due to the high specific gravity (9.5) of this metal. It is therefore necessary to ensure a “minimum rotation” of Bi (R agent) in the oxidation loop 200 of 5.9 cm³/s, a particularly low volume flow rate.

Since the molar stoichiometric ratio of the reduction reaction Rrs (Bi₂O₃/CH₄) is 1.33, the stoichiometric consumption of Bi₂O₃ is 1.33×0.1=0.133 mol/s, the mass stoichiometric consumption of bismuth borate is 0.133×386.7=51.4 g/s, i.e. a “minimum rotation” of 51.4/7=7.3 cm³/s of bismuth borate (O agent), a volume flow rate which is also low.

The device is that shown in FIG. 1, with a single-compartment tank.

Discharge conduits 213 and 313 with internal diameters equal to 5 cm are chosen to ensure rapid discharge of the separation devices 208, 308.

The first injection device 205 is of airlift type and the second injection device 305 is an ejector supplied with methane.

The material making up the walls of the device is a refractory ceramic based for example on alumina, aluminosilicate (MgAl₂O₄ spinel) or cordierite, or silicon carbide or nitride, or refractory steel.

Before starting the method, the tank 100, loaded with solid bismuth and bismuth borate, is brought to approximately 650° C. by heating (for example electric induction heating) to form a layer of R phase (molten Bi) at the bottom of the tank and, above it, a layer of O phase (molten bismuth borate).

The fuel flow rate is adjusted to 0.1 mol/s and the air flow rate to 0.952 mol/s: these flow rates are proportional to one another and kept constant.

The second injection device 305 injecting methane, the flow rate of which is therefore 0.1 mol/second (2.24 NL/s), creates a flow rate driving the phase rich in liquid bismuth borate of the order of 500 cm³/s, a flow rate which is much higher than the “minimum rotation” of 7.3 cm³/s corresponding to reaction (5) under stoichiometric conditions. Consequently, the O agent (Bi₂O₃) driven is very much in excess compared to the methane, which allows complete oxidation of the fuel to CO₂/H₂O. Furthermore, the flow rate of 500 cm³/s of liquid discharged by the discharge conduit 213 of diameter 5 cm (i.e. a section of 20 cm²) descends therein at a speed of 500/20=25 cm/s, a value much lower than 0.5 m/s.

The first injection device 205 injecting air, having a flow rate of 0.952 mol/second, creates a flow rate driving the phase rich in liquid bismuth of the order of 1 L/s (1000 cm³/s), a flow rate which is much higher than the “minimum rotation” of 5.9 cm³/s corresponding to reaction (4) under stoichiometric conditions. The R agent (Bi) driven is therefore also very much in excess compared to the air and the oxidation reaction (4) is therefore complete. Furthermore, the flow rate of 1 L/s (1000 cm³/s) of liquid discharged by the discharge conduit 313 of diameter 5 cm descends therein at a speed of 1000/20=50 cm³/s, a value much lower than 0.5 m/s.

As the air and fuel flow rates are proportional, the reserves of R and O contained in the liquid as well as the levels of the liquids and the interface 103 are constant, which allows particularly easy continuous operation.

The temperature of the liquid phases and the gaseous effluents exceeds 700° C. after a few minutes: the electric heating is stopped, the O phase being molten and therefore no longer needing to be heated.

### Second Embodiment

Again, the fuel is natural gas, likened to methane. The target is also a power of 80 kW. This time, use is made of a device with an inerting circuit, as shown in FIG. 6, and with a two-compartment tank, the separation devices 208, 308 having the same materials and the same geometry as in example 1.

Discharge conduits 213, 313 with internal diameters equal to 7 cm are chosen to ensure rapid discharge of the separation devices 208 and 308.

The single-phase, in which the O and R agents are essentially in the form of dispersed fine particles. The liquid substrate consists of a meltable mixture MS which has the following composition: 8.5% (in moles) Na₂SO₄-78% Li₂SO₄-13.5% K₂SO₄, eutectic of Tₘ 512° C. and of molecular weight of 121.4 g/mol.

The R and O agents are respectively metallic copper (Cu(0)) and cupric oxide CuO.

These reducing and oxidizing agents are prepared, in the form of fine particles, via polyol synthesis carried out as follows:

In a first preparation, copper nitrate is added to glycerol containing sodium hydroxide; the mixture is heated with stirring at between 120 and 140° C. and the nanometric CuO particles obtained are separated by filtration, and washed and recovered.

In a second preparation, copper nitrate is also added to glycerol containing sodium hydroxide, this time in the presence of hydrazine, which is a reducing reagent. The mixture is also heated with stirring at between 140 and 160° C. and the nanometric particles of metallic Cu obtained are separated by filtration, and washed and recovered.

The redox reactions developed in the combustion device are:

4Cu+2(O₂+kN₂→4CuO+2kN₂ (6)

CH₄+4CuO→CO₂+2H₂O+4Cu (7)

The tank 100 containing the mixture “MS” is brought to approximately 550° C. to melt the mixture, using an electric heating device. In this molten mixture, which itself has no redox properties, 15%, in moles, of the metallic copper (Cu(0)) previously obtained and 15% in moles of CuO are incorporated, these two agents then being in the form of dispersed fine particles.

The flow rates of fuel and air are adjusted to 0.1 mol/s and 0.952 mol/s respectively. As these flow rates are proportional, the reserves of Cu(11) and Cu(0) and the liquid levels are unchanged. The atmospheres 220, 320 of the compartments are placed under a nitrogen overpressure of approximately 0.15 bar, which causes the liquid to rise by a height of approximately 50 cm in the separation devices 208 and 308, which increases the liquid/gas contact times in the latter and therefore enhances reactions (6) and (7).

The temperature of the liquid phases and the gaseous effluents exceeds 600° C. after a few minutes: the electric heating is stopped, the O phase being molten and therefore no longer needing to be heated.

It is also demonstrated, on the one hand, that the agents R (Cu(0)) and O (CuO) are very much in excess compared to the minimum rotations required to reduce the oxygen in the air and oxidize the methane, respectively and, on the other hand, that the flow rates of liquids discharged through the discharge conduits 213, 313 with diameters of 7 cm (i.e. a section of 38.5 cm²) descend therein at speeds much lower than 0.5 m/s.

1-11. (canceled)

12. A device for chemical looping combustion of a fuel, comprising:
at least one tank arranged to receive a liquid comprising at least one oxidizing agent and at least one reducing agent together forming at least one redox couple,
an oxidation loop comprising:
a first conduit comprising a first inlet opening into the tank, arranged to take in a first part of the liquid comprising at least the reducing agent, and a first outlet,
a first injection device, connected to a first supply of a first driving fluid comprising dioxygen, and arranged to introduce the first driving fluid into the first conduit, where said first driving fluid is in contact with the reducing agent, at least a fraction of which is then oxidized to an oxidizing agent, and
a first separation device connected to the first outlet and arranged to separate the first driving fluid, depleted in dioxygen, from the liquid and to return the separated liquid to the tank, and
a reduction loop comprising:
a second conduit comprising a second inlet opening into the tank, arranged to take in a second part of the liquid comprising at least the oxidizing agent, and a second outlet, and
a second injection device connected to a supply of a second driving fluid comprising a fuel comprising carbon, and arranged to introduce the second driving fluid into the second conduit, where said second driving fluid is in contact with the oxidizing agent, at least a fraction of which is then reduced to a reducing agent, and
a second separation device connected to the second outlet and arranged to separate the second driving fluid, enriched with carbon dioxide, from the liquid and to return the separated liquid to the tank.

13. The device as claimed in claim 12, wherein the first separation device and the second separation device each comprise:
a tapping connection via which the first or second separation device is connected to the first or second conduit,
a vent opening out of the tank, and
a liquid discharge conduit comprising a lower end opening into the tank.

14. The device as claimed in claim 12, wherein the device also comprises a pressurized inert gas circuit, the inert gas comprising water vapor or nitrogen, said inert gas circuit comprising:
an inert gas supply conduit opening into a top part of the tank via a first valve, and
an outlet vent opening into the top part of the tank via a vent valve.

15. A method for chemical looping combustion using a device as claimed in claim 12, the method comprising steps of:
placing in the tank a liquid containing at least one oxidizing agent and reducing agent,
introducing the first driving fluid into the first conduit by means of the first injection device, and taking in, by the driving effect, the first part of the liquid through the first inlet,
circulating the liquid in the first conduit, bringing the liquid and the first driving fluid into contact and reaction between the reducing agent and the dioxygen,
separating, in the first separation device, the liquid and a first gaseous effluent resulting from the reaction between the first driving fluid and the liquid, returning the separated liquid to the tank and discharging the first gaseous effluent,
introducing the second driving fluid into the second conduit by means of the second injection device and taking in, by the driving effect, the second part of the liquid through the second inlet,
circulating the liquid in the second conduit, bringing the liquid and the second driving fluid into contact and reaction between the oxidizing agent and the fuel, and
separating, in the second separation device, the liquid and a second gaseous effluent resulting from the reaction between the second driving fluid and the liquid, returning the separated liquid to the tank and discharging the second gaseous effluent.

16. The method as claimed in claim 15, wherein a ratio of the flow rates of injection of the first and second driving fluids into the first and second conduits respectively, is kept constant and is chosen in such a way as to react the fuel and the dioxygen in stoichiometric proportions in the device.

17. The method as claimed in claim 15, further comprising a step of:
flushing an atmosphere of the tank with an inert gas.

18. The method as claimed in claim 17, wherein a pressure of the atmosphere of the tank is kept higher than both a pressure in the first separation device and a pressure in the second separation device, by at least partially closing a vent valve of the tank.

19. The method as claimed in claim 15, wherein the entire device is maintained at a pressure which is higher than a pressure outside the device and which is greater than or equal to 100 kilopascals.

20. The method as claimed in claim 15, wherein the reducing agent comprises copper in metallic form Cu(0) and/or in the form of Cu(I) oxide and the oxidizing agent comprises copper in the form of Cu(II) oxide, the reducing agent and oxidizing agent being contained in the liquid in the form of dispersed solid particles.

21. The method as claimed in claim 15, wherein the reducing agent comprises at least one metal or oxide of a metal chosen from copper, iron, nickel, chromium, molybdenum, tungsten, vanadium and cerium and the oxidizing agent comprises at least one other oxide of the same metal having a higher degree of oxidation.

22. The method as claimed in claim 15, wherein the reducing agent comprises at least one metal chosen from tin, bismuth and lead, and the oxidizing agent comprises at least one oxide of the same metal.
